(19) United States
(12) Patent Application Publication
(10) Pub. No.: US 2024/0072971 A1
(43) Pub. Date: Feb. 29, 2024

(54) METHODS AND SYSTEMS OF UPLINK CELL AND SCELL ACTIVATION

(71) Applicant: ZTE CORPORATION, Shenzhen (CN)

(72) Inventors: Xingguang WEI, Shenzhen (CN); Junfeng ZHANG, Shenzhen (CN); Xianghui HAN, Shenzhen (CN); Peng HAO, Shenzhen (CN); Shuaihua KOU, Shenzhen (CN); Hanchao LIU, Shenzhen (CN)

(73) Assignee: ZTE CORPORATION, Shenzhen (CN)

(21) Appl. No.: 18/506,196

(22) Filed: Nov. 10, 2023

Related U.S. Application Data
(63) Continuation of application No. PCT/CN2022/087311, filed on Apr. 18, 2022.

(51) Int. Cl. H04L 5/00; H04W 24/10

(52) U.S. Cl. CPC H04L 5/0051; H04L 5/0098; H04W 24/10

(57) ABSTRACT

The present disclosure is directed to UL cell and SCell activation, including sending, by a base station to a wireless communication device, a Secondary Cell (SCell) activation command triggering at least SCell activation and measurement signal for at least one SCell, and receiving, by the base station from the wireless communication device, the measurement signal in response to the SCell activation command, wherein the wireless communication device activates the at least one SCell in response to the SCell activation command.

### CROSS-REFERENCE TO RELATED APPLICATION

This application claims the benefit of priority under 35 U.S.C. § 120 as a continuation of International Patent Application No. PCT/CN2022/087311, filed on Apr. 18, 2022, the disclosure of which is incorporated herein by reference in its entirety.

### TECHNICAL FIELD

The disclosure relates generally to wireless communications and, more particularly, to systems, methods, and non-transitory computer-readable media for uplink (UL) cell and SCell activation.

### BACKGROUND

A Cell in the New Radio (NR) system has one of three configuration. A first configuration includes one Downlink (DL) carrier. A second configuration includes one DL carrier and one UL carrier. A third configuration includes one DL carrier and two UL carriers, where one of the two UL carriers is a Supplementary Uplink (SUL). A Base Station (BS) and User Equipment (UE) communicates with each other by using the time-frequency resources in each carrier. If a base station configures one cell for the UE for communication, the base station must configure one DL carrier in this cell. Where a UE only has UL-centric mobile services, for the existing NR system, the base station must configure multiple cells including multiple DL carriers and multiple UL carriers for the UE. However, DL carriers do not account for a UE that only has UL-centric mobile services with small DL traffic.

### SUMMARY

A wireless communication method, can include receiving, by a first cell, uplink transmission from a wireless communication device using an uplink carrier of the first cell, where the first cell lacks any downlink carrier, sending, by a second cell, downlink transmission for the first cell to the wireless communication device using a downlink carrier of the second cell, where the downlink transmission for the first cell includes at least one of control channel information for the first cell, a synchronization signal for the first cell, or a reference signal for the first cell.

A wireless communication method, can include sending, by a wireless communication device, uplink transmission to a first cell using an uplink carrier of the first cell, where the first cell lacks any downlink carrier, receiving, by the wireless communication device, downlink transmission for the first cell from a second cell using a downlink carrier of the second cell, where the downlink transmission for the first cell includes at least one of control channel information for the first cell, a synchronization signal for the first cell, or a reference signal for the first cell.

A wireless communication method can include sending, by a base station to a wireless communication device, a Secondary Cell (SCell) activation command triggering at least SCell activation and measurement signal for at least one SCell, and receiving, by the base station from the wireless communication device, the measurement signal in response to the SCell activation command, where the wireless communication device activates the at least one SCell in response to the SCell activation command.

A wireless communication method can include receiving, by a wireless communication device from a base station to a Secondary Cell (SCell) activation command triggering at least SCell activation and measurement signal for at least one SCell, and in response to receiving the SCell activation command, sending, by wireless communication device to the base station, the measurement signal, and activating, by the wireless communication device, the at least one SCell.

A wireless communication apparatus can include at least one processor and a memory, where the at least one processor is configured to read code from the memory and implement a method in accordance with present implementations.

A computer program product can include a computer-readable program medium code stored thereupon, the code, when executed by at least one processor, causing the at least one processor to implement a method in accordance with present implementations. The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, and/or system, in which techniques disclosed herein may be implemented, in accordance with some arrangements.

FIG. 2 illustrates a block diagram of an example wireless communication system for transmitting and receiving wireless communication signals in accordance with some arrangements.

FIG. 3 is a diagram illustrating an SRS resource configuration for uplink (UL) cell and SCell activation, according to various arrangements.

FIG. 4 is a diagram illustrating medium access control (MAC) control element (CE) configuration for uplink (UL) cell and SCell activation, according to various arrangements.

FIG. 5 is a diagram illustrating a first example method for uplink (UL) cell and SCell activation, according to various arrangements.

FIG. 6 is a diagram illustrating a second example method for uplink (UL) cell and SCell activation, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

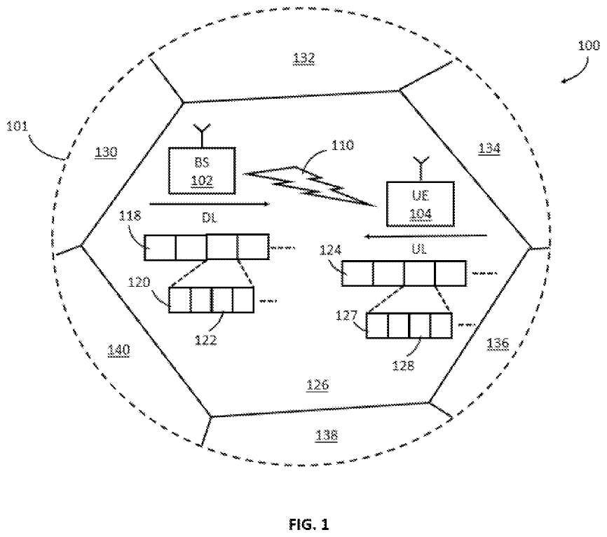

FIG. 1 illustrates an example wireless communication network, and/or system, 100 in which techniques disclosed herein may be implemented, in accordance with an arrangement of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (also referred to as wireless communication node) and a UE device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the base station 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the base station 102 and UE 104 are described herein as non-limiting examples of “communication nodes,” generally, which can practice the methods disclosed herein. Such communication nodes may be capable of wireless and/or wired communications, in accordance with various arrangements of the present solution.

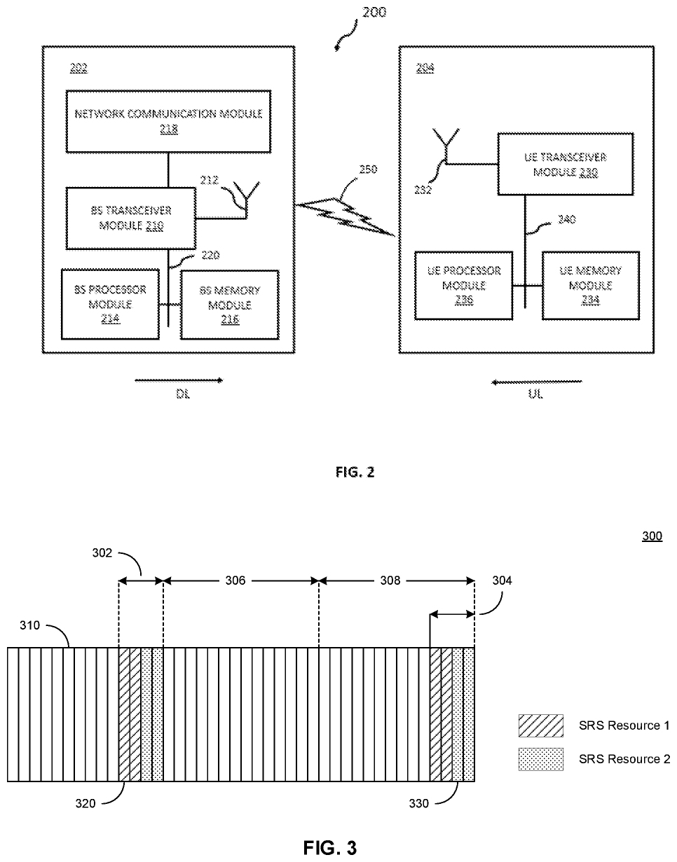

FIG. 2 illustrates a block diagram of an example wireless communication system 200 for transmitting and receiving wireless communication signals (e.g., OFDM/OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some arrangements, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), gNB, a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

Present implementations can include One Cell (Cell A) that contains one UL carrier without a DL carrier. The corresponding DL signals or channels for Cell A are transmitted on the DL carrier of another Cell (Cell B). The corresponding DL signals or channels for Cell A can include at least one of various signaling configurations. A signaling configuration can include a PDCCH scheduling Physical Uplink Shared Chanel (PUSCH) on Cell A. A signaling configuration can include a PDCCH that is used for activating Configured Grant-PUSCH CG-PUSCH) on Cell A. A signaling configuration can include a PDCCH triggering aperiodic Sounding Reference Signal (SRS) on Cell A. A signaling configuration can include a PDCCH scheduling SIB (System Information Block) for Cell A. A signaling configuration can include a PDCCH scheduling PUSCH or PDSCH during the random access procedure. A signaling configuration can include a Primary Synchronization Signal (PSS), Secondary Synchronization Signal (SSS) and Physical Broadcast Channel (PBCH) for Cell A. A signaling configuration can include a DMRS for PDCCH, PDSCH or PBCH for Cell A.

Present implementations can be directed to cross-carrier scheduling configuration and PDCCH configuration. If one Cell (Cell A) contains one UL carrier but without DL carrier, the base station configures another Cell (Cell B) as the scheduling Cell for Cell A. The base station then transmits the corresponding DL signals or channels for Cell A on Cell B. Cell B can schedule signals or channels for Cell B and can also schedule signals or channels for Cell A. The base station can configure separate CORESET and Search Space configurations for scheduling signals or channels for Cell A and for scheduling signals or channels for Cell B. The base station can configure the same CORESET and Search Space configuration for scheduling signals or channels for Cell A and for scheduling signals or channels for Cell B. The Base station can configure different carrier indicator values for Cell B. The UE determines whether the PDCCH transmitted on Cell B is for scheduling signals or channels on Cell B or Cell A based on this carrier indicator.

Present implementations can demonstrate various advantages. For UE with UL-centric mobile services, a base station can advantageously configure cells with only UL carrier to the UE. This can increase the spectrum efficiency, since unnecessary DL carriers are not configured to the UE. Furthermore, this can also help with the UE power saving since UE doesn't need to monitor DL signals or channels on these unnecessary DL carriers.

A wireless communication method, can include receiving, by a first cell, uplink transmission from a wireless communication device using an uplink carrier of the first cell, where the first cell lacks any downlink carrier, sending, by a second cell, downlink transmission for the first cell to the wireless communication device using a downlink carrier of the second cell, where the downlink transmission for the first cell includes at least one of control channel information for the first cell, a synchronization signal for the first cell, or a reference signal for the first cell.

In some aspects, the control channel information for the first cell includes at least one of a Physical Downlink Control Channel (PDCCH) used for scheduling the uplink transmission for the first cell, a PDCCH used for activating a configured grant for the uplink transmission for the first cell, a PDCCH used for triggering aperiodic Sounding Reference Signal (SRS) for the first cell, a PDCCH used for scheduling System Information Block (SIB) for the first cell, or a PDCCH used for scheduling the uplink transmission during a random access procedure.

In some aspects, the synchronization signal for the first cell includes at least one of a Primary Synchronization Signal (PSS) for the first cell, a Secondary Synchronization Signal (SSS) for the first cell, or a Physical Broadcast Channel (PBCH) for the first cell.

A wireless communication method, can include sending, by a wireless communication device, uplink transmission to a first cell using an uplink carrier of the first cell, where the first cell lacks any downlink carrier, receiving, by the wireless communication device, downlink transmission for the first cell from a second cell using a downlink carrier of the second cell, where the downlink transmission for the first cell includes at least one of control channel information for the first cell, a synchronization signal for the first cell, or a reference signal for the first cell.

Present implementations can include SCell activation command triggering both SCell activation and SRS. An SCell activation procedure can be triggered by Medium Access Control Control Element (MAC CE) or Radio Resource Control (RRC) signaling. During the SCell activation procedure, a UE can receive the SCell activation command and transmit a Hybrid automatic repeat request acknowledgement (HARQ-ACK) feedback if necessary. The SCell activation command can include MAC CE or RRC signaling. Then, the UE receives Synchronization Signals or Physical Broadcast Channel (SS/PBCH) or Channel State Information-Reference Signal (CSI-RS) to perform Automatic Gain Control (AGC) adjustment and time or frequency synchronization for downlink. After this, a UE can measure CSI-RS and transmit a valid CSI report.

The existing SCell activation procedure can be exempt from application to the Cell that contains one UL carrier without DL carrier, because a UE is not required to perform AGC adjustment and time or frequency synchronization for downlink. Instead, the UE can adjust its UL Timing Advance (TA), adjust transmitting power, and send reference signals for base station for UL channel measurement, for example. One SCell activation command can trigger both SCell activation and SRS for one or multiple SCells. When one UE receives this SCell activation command to activate one SCell, the UE transmits an SRS on the SCell to the gNB. Before transmitting the SRS, the UE may need some time to prepare and adjust its Radio Frequency (RF) chain. The SCell activation command triggering both SCell activation and SRS is not restricted to an SCell containing UL carrier without DL carrier. The SCell activation command can also be applied to an SCell with both a DL carrier and an UL carrier. For example, even if the DL carrier is configured to the SCell, the SCell can be used for UL transmission and cross-carrier scheduling configured for this SCell.

A wireless communication method can include sending, by a base station to a wireless communication device, a Secondary Cell (SCell) activation command triggering at least SCell activation and measurement signal for at least one SCell, and receiving, by the base station from the wireless communication device, the measurement signal in response to the SCell activation command, where the wireless communication device activates the at least one SCell in response to the SCell activation command.

In some aspects, the SCell activation command further triggers aperiodic Channel State Information Reference Signal (CSI-RS), the method further includes sending, by the base station to the wireless communication device, the aperiodic CSI-RS for the at least one SCell on one or more of the at least one SCell, and the wireless communication device sends the measurement signal after receiving the aperiodic CSI-RS.

A wireless communication method can include receiving, by a wireless communication device from a base station to a Secondary Cell (SCell) activation command triggering at least SCell activation and measurement signal for at least one SCell, and in response to receiving the SCell activation command, sending, by wireless communication device to the base station, the measurement signal, and activating, by the wireless communication device, the at least one SCell.

Present implementations can include SCell activation command triggering SCell activation, CSI-RS and SRS. One SCell activation command can trigger SCell activation, and aperiodic CSI-RS and SRS for one or multiple SCells. As one example, a base station transmits the SCell activation command to the UE. If the SCell activation command indicates to activate one certain SCell, then the base station transmits aperiodic CSI-RS on the SCell. The CSI-RS on the SCell can serve the purpose of time or frequency synchronization. The UE transmits the SRS on the SCell after the CSI-RS. The aperiodic CSI-RS can contain one or two CSI-RS bursts. The CSI-RS burst can be defined as four CSI-RS resources in two consecutive slots.

In some aspects, the SCell activation command further triggers aperiodic Channel State Information Reference Signal (CSI-RS), the method further includes sending, by the wireless communication device from the base station, the aperiodic CSI-RS for the at least one SCell on one or more of the at least one SCell, and the wireless communication device sends the measurement signal after receiving the aperiodic CSI-RS.

Present implementations can include a TA/TPC/UL spatial command. After UE transmitting the SRS for SCell activation, base stations transmits at least one of the following commands to the UE. Once UE receives at least one of various commands or channel, the UE can complete the SCell activation procedure. Various commands can include a TA adjustment command. Various commands can include a Transmit power control (TPC) command. Various commands can include an UL spatial relation indication command. Various commands can include a Physical Downlink Control Channel (PDCCH) on the SCell or PDCCH for the SCell. The TA adjust command can adjust the uplink transmitting timing advance and TA adjustment command can be carried by MAC CE. “Timing Advance Command MAC CE” and “Absolute Timing Advance Command MAC CE” are typical MAC CEs for UE to adjust the uplink transmitting timing advance. Base station measures the SRS transmitted by the UE and send TA adjustment command based on the measurement of the SRS.

The method can include transmitting, by the base station to the wireless communication device after the wireless communication device sends the measurement signal for the SCell activation, at least one of a Time Alignment (TA) adjustment command, a Transmit power control (TPC) command, an uplink spatial relationship indication command, a Physical Downlink Control Channel (PDCCH) on the at least one SCell, or a PDCCH for the at least one SCell.

In some aspects, the measurement signal includes a number of bursts, the number is an integer larger than 0, the number is indicated by the base station or a default number, the burst is at least one of a first number of Sounding Reference Signal (SRS) resources in one slot, where the first number is integer number larger than 0, a second number of SRS resources in each of a third number of slots, where each of the second number and the third number is an integer number larger than 1, or one SRS resource set.

In some arrangements, where a time gap between two consecutive bursts is configured or indicated to the wireless communication device by the base station, where the time gap is a non-negative integer, the time gap is defined by a number of time-domain resources, the wireless communication device transmits a subsequent one of the two consecutive bursts the time gap after an end of a preceding one of the two consecutive bursts, or indication of the time gap by the base station is absent, and the time gap is 0.

In some arrangements, where the measurement signal includes a number of bursts, the number of bursts is 2 in response to a time gap between two consecutive bursts is indicated to the wireless communication device by the base station, and one of indication of the number by the base station being absent, or the base station configures, or indicates the number to be 1.

The method can further include receiving, by the wireless communication device from the base station after the wireless communication device sends the measurement signal for the SCell activation, at least one of commands including a Time Alignment (TA) adjustment command, a Transmit power control (TPC) command, an uplink spatial relationship indication command, a Physical Downlink Control Channel (PDCCH) on the at least one SCell, or a PDCCH for the at least one SCell, where the wireless communication device completes the SCell activation after receiving the at least one of the commands.

In some aspects, the measurement signal includes a number of bursts, the number is an integer larger than 0, the number is indicated by the base station or a default number, the burst is at least one of a first number of Sounding Reference Signal (SRS) resources in one slot, where the first number is integer number larger than 0, a second number of SRS resources in each of a third number of slots, where each of the second number and the third number is an integer number larger than 1, or one SRS resource set.

In some aspects, a time gap between two consecutive bursts is configured or indicated to the wireless communication device by the base station, where the time gap is a non-negative integer, the time gap is defined by a number of time-domain resources, the wireless communication device transmits a subsequent one of the two consecutive bursts the time gap after an end of a preceding one of the two consecutive bursts, or configuration or indication of the time gap by the base station is absent, and the time gap is 0.

In some aspects, the measurement signal includes a number of bursts, the number of bursts is 2 in response to a time gap between two consecutive bursts is configured or indicated to the wireless communication device by the base station, and one of configuration or indication of the number by the base station being absent, or the base station configures or indicates the number to be 1.

A TPC command can adjust the uplink transmitting power. TPC command can be carried by DCI. The “TPC command for scheduled PUSCH” field in DCI format 00, 0_1 and 0_2 can be used to adjust the PUSCH transmitting power. The “TPC command for scheduled PUCCH” field in DCI format 1_0, 1_1 and 1_2 can adjust the PUCCH transmitting power. The TPC commands in DCI format 2_2 can adjust the PUCCH and PUSCH transmitting power for a group of UEs. TPC commands in DCI format 2_3 can adjust the transmitting power for SRS for a group of UEs. The base station measures the SRS transmitted by the UE and send TPC command based on the measurement of the SRS.

The UL spatial relation indication command can activate or update the UL spatial relation for UL signals or channels. The UL spatial relation indication command can be carried by MAC CE. “Enhanced PUCCH Spatial Relation Activation/Deactivation MAC CE” can update the spatial relation for PUCCH transmission. “Enhanced SP/AP SRS Spatial Relation Indication MAC CE” can update the spatial relation for SRS transmission. “Serving Cell Set based SRS Spatial Relation Indication MAC CE” can update the spatial relation for SRS transmission for SRS transmission for serving cell set. Base station measures the SRS transmitted by the UE and send UL spatial relation indication command based on the measurement of the SRS. If UE receives a PDCCH on the SCell, it can indicate that a base station is ready to transmit signals or channels for the UE on this SCell. In other words, the SCell activation procedure has been finished. Similarly, if UE receives a PDCCH for the SCell, it can indicate that base station is ready to transmit signals or channels for the UE on this SCell. In this case, the PDCCH for the SCell can be transmitted on other Cells. The PDCCH can be used to schedule PDSCH/PUSCH for the UE on the SCell, or to trigger reference signals (e.g., SRS, CSI-RS and etc.) on the SCell.

FIG. 3 is a diagram illustrating an SRS resource configuration for uplink (UL) cell and SCell activation, according to various arrangements. As illustrated by way of example in FIG. 3, an example configuration 300 can include a plurality of symbols 310, including a plurality of first SRS resource symbols 320 and a plurality of second SRS resource symbols 330. The configuration 300 can include a first SRS burst 302 encompassing one or more of the first SRS resource symbols 320 and the second SRS resource symbols 330. The configuration 300 can include a second SRS burst 304 encompassing one or more of the first SRS resource symbols 320 and the second SRS resource symbols 330. The configuration 300 can include a gap 306 between the first SRS burst 302 and the second SRS burst 304 that includes one or more of the symbols 310. The configuration 300 can include a slot 308 that includes one or more of the symbols 310, the first SRS resource symbols 320, the second SRS resource symbols 330, and the second SRS burst 304.

Present implementations can include SRS bursts. As one example, one SCell activation command triggers SCell activation and SRS for one certain SCell. The SRS for the SCell contains M SRS bursts, where M is integer number larger than 0. If base station doesn't configure/indicate M, the SRS for each SCell contains one burst by default. The SRS burst can be defined as one of various configurations. A configuration can include N SRS resource(s) in one slot, where N is integer number larger than 0. A configuration can include P SRS resources in each of Q slots, where P and Q are integer number larger than 1. A configuration can include one SRS resource set. The SRS burst can be defined as 2 SRS resources in one slot, where each SRS resource occupies 2 adjacent OFDM symbols. As another example, the SRS burst can be defined as 2 SRS resources in each slot of the 2 consecutive slots, where each SRS resource occupies 2 adjacent OFDM symbols. If M is equal to 1, UE can only transmit the SRS burst once. If M is larger than 1, UE can transmit the SRS burst M times in consecutive UL slots. All the M SRS bursts have the same antenna port configuration, the same OFDM symbol allocations in a slot and the same PRB allocation location.

A time gap of T between each consecutive two SRS bursts can be configured/indicated to the UE, where T is nonnegative integer number and T is in the unit of symbol/slot/sub-frame. UE transmits the SRS burst T symbol/slot/sub-frame after the end of the preceding SRS burst. If base station doesn't configure/indicate the gap, the gap is 0 by default. As one example, if base station doesn't configure/indicate M or if base station configures/indicates M as 1, the SRS contains 2 SRS bursts if a gap is configured by the base station. As one example, a base station configures/indicates the SRS burst as 2 SRS resources. Each of the 1st SRS resource and the 2nd SRS resource occupies 2 symbols. Base station configures/indicates 2 SRS bursts for the UE and the gap in between is 1 slot. Thus, overall, M is equal to 2, N is equal to 2 and gap is equal to 1 slot as shown in FIG. 3.

Present implementations can include other configurations of the SRS. In the NR system, the base station can configure/indicate SRS as periodic SRS, semi-persistent SRS and aperiodic SRS. For periodic SRS, UE transmits the SRS periodically with a time pattern. For semi-persistent SRS, UE transmits the SRS periodically with a time pattern once it is activated by an activation command. However, if semi-persistent SRS is deactivated, the UE stops transmitting the SRS. For aperiodic SRS, UE transmits the SRS once when it receives the triggering command from the base station.

In the NR system, the base station can configure/indicate usage of SRS as “beamManagement”, “codebook”, “nonCodebook” or “antennaSwitching”. If the usage of SRS is configured as “beamManagement”, the SRS can perform uplink beam management. If the usage of SRS is configured as “codebook”, the SRS can determine the UL channel condition in case of codebook based UL transmission. If the usage of SRS is configured as “nonCodebook”, the SRS can determine the UL channel condition in case of non-codebook based UL transmission. If the usage of SRS is configured as “antennaSwitching”, the SRS can determine the DL CSI (Channel State Information).

The SRS triggered by the SCell activation command can be aperiodic SRS. The usage of the SRS triggered by the SCell activation command can be configured as “beamManagement.” This allows the gNB to perform UL beam management during the SCell activation procedure and can facilitate the SCell activation procedure.

In some aspects, for the SCell activation, the measurement signal triggered by the SCell activation command is aperiodic Sounding Reference Signal (SRS).

Present implementations can include a timeline requirement for SRS. If the SCell activation command is a MAC CE or DCI, then the following timeline can apply. Upon receiving SCell activation command in slot n, the UE can transmit SRS for the SCell being activated no earlier than slot n+k=n+m+p*N_slot\hat{ }(subframe,u)+1, where slot n+m is a slot indicated for PUCCH transmission with HARQ-ACK information for the PDSCH reception containing the MAC-CE or the PDCCH containing the DCI. N_slot\hat{ }(subframe,u) is a number of slots per subframe for the SCS configuration u of the PUCCH transmission. p is nonnegative integer number. For SCell activation command carried by MAC CE, p is equal to 3 typically. For SCell activation command carried by DCI, p can be other values, e.g., 1 or 2.

Upon receiving SCell activation command in slot n, the UE can transmit SRS for the SCell being activated no later than slot n+k=n+(T1+T2+T3)/slotlength, where T1 (in ms) is the timing between the PDSCH reception containing the MAC-CE and the corresponding PUCCH transmission with HARQ-ACK information, or the timing between the PDCCH reception containing the DCI and the corresponding PUCCH transmission with HARQ-ACK information. T2 (in ms) can be the time period for UE to prepare and adjust its RF chain. T3 (in ms) is the time period for UE to transmit SRS. slotlength is the slot length of the slot of the SCell being activated.

If the SCell activation command is a RRC signaling, then the following timeline can apply. Upon receiving SCell activation command in slot n, the UE can transmit SRS for the SCell being activated no earlier than slot n+k=n+m+T0+1, where slot n+m is a slot indicated for PUCCH transmission with HARQ-ACK information for the PDSCH reception containing the SCell activation command. T0 is the time period for processing the RRC signaling including the time period for potential transmission of RRCConnectionReconfigurationComplete message.

Upon receiving SCell activation command in slot n, the UE can transmit SRS for the SCell being activated no later than slot n+k=n+(T0+T1+T2+T3)/slotlength, where T1 (in ms) is the time period between the PDSCH reception containing the SCell activation command and the corresponding PUCCH transmission with HARQ-ACK information. T2 (in ms) is the time period for UE to prepare and adjust its RF chain. T3 (in ms) is the time period for UE to transmit SRS. slotlength is the slot length of the slot of the SCell being activated. T0 is the time period for processing the RRC signaling including the time period for potential transmission of RRCConnectionReconfigurationComplete message.

The method can further include indicating, by the base station to the wireless communication device a slot offset for the SCell, where the slot offset is a non-negative integer number, an earliest slot of a first SRS burst starts at a slot that is the slot offset after a latest SCell slot coinciding with a reference slot of a cell.

Present implementations can include a timeline requirement for SRS. The UE can receive the SCell activation command that triggers one or multiple SRS bursts for one or more deactivated SCell(s) for SCell activation. As one example, if the SCell activation command indicates that the SRS for SCell activation is present in an SCell, then the UE transmits the SRS on the SCell. If base station configures/indicates a slot offset Soffset for the SCell, the first slot of the first SRS burst starts at Soffset slot after the last SCell slot coinciding with the reference slot n+k of the cell in which the corresponding PUCCH transmission with HARQ-ACK information was transmitted or of the cell in which the SCell activation command was received. Soffset can be a nonnegative integer number. As another example, if a base station configures/indicates M (M>1) SRS bursts are present in an SCell, then the UE transmits the second SRS burst on the SCell for SCell activation. The first slot of the second SRS burst starts at the T SCell slot after the end of the first SRS burst, where T is a time gap between each two SRS bursts configured/indicated by the base station. If the time gap is configured/indicated in the unit of symbol/sub-frame, it can be transformed into the unit of slot. Similarly, the UE transmits the next SRS burst with gap between this SRS burst and the preceding SRS burst.

The method can further include receiving, by the wireless communication device from the base station, a slot offset for the SCell, where the slot offset is a non-negative integer number, an earliest slot of a first SRS burst starts at a slot that is the slot offset after a latest SCell slot coinciding with a reference slot of a cell.

The method can further include receiving, by wireless communication device from the base station, a number of bursts for the measurement signal in a SCell of the at least one SCell, the number being greater than 1, and sending, by the wireless communication device to the base station, a subsequent burst on the SCell for the SCell activation, where an earliest slot of the subsequent burst starts at a slot that is a time gap after an end of a preceding burst, the time gap is indicated by the base station.

In some aspects, the measurement signal includes a number of Sounding Reference Signal (SRS) bursts, and an earliest slot of a preceding burst of the SRS bursts starts a number of time-domain resources after the latest SCell uplink slot coinciding with a latest downlink slot of a last Channel State Information Reference Signal (CSI-RS) burst.

The method can further include indicating, by the base station to the wireless communication device, a number of bursts for the measurement signal in a SCell of the at least one SCell, the number being greater than 1, and receiving, by the base station from the wireless communication device, a subsequent burst on the SCell for the SCell activation, where an earliest slot of the subsequent burst starts at a slot that is a time gap after an end of a preceding burst, the time gap is indicated by the base station.

Present implementations can include a timeline requirement for SRS and CSI-RS. In one embodiment, one SCell activation command triggers SCell activation, aperiodic CSI-RS and SRS for one or multiple SCells. The base station transmits the SCell activation command to the UE, if the SCell activation command indicates to activate one certain SCell, then base station transmits aperiodic CSI-RS on the SCell. The CSI-RS on the SCell can serve the purpose of time/frequency synchronization. The UE can transmit the SRS on the SCell after the CSI-RS. As one example, the aperiodic CSI-RS contains one or two CSI-RS bursts. A CSI-RS burst can be defined as four CSI-RS resources in two consecutive slots. As described with respect to SRS bursts, an example SRS contains one or multiple SRS bursts. The first slot of the first SRS burst starts at X slot(s) after the last SCell slot coinciding with the last slot of the last CSI-RS burst. X is the slot offset configured/indicated by the base station. X can be a nonnegative integer number.

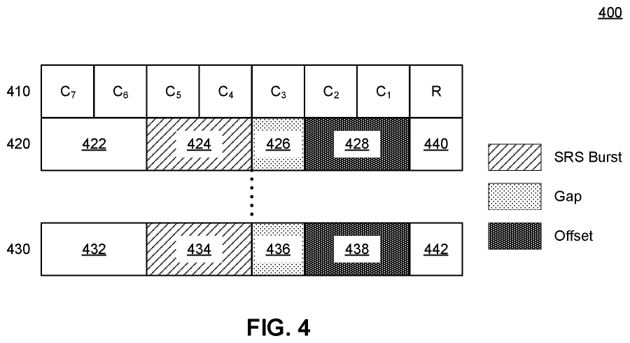

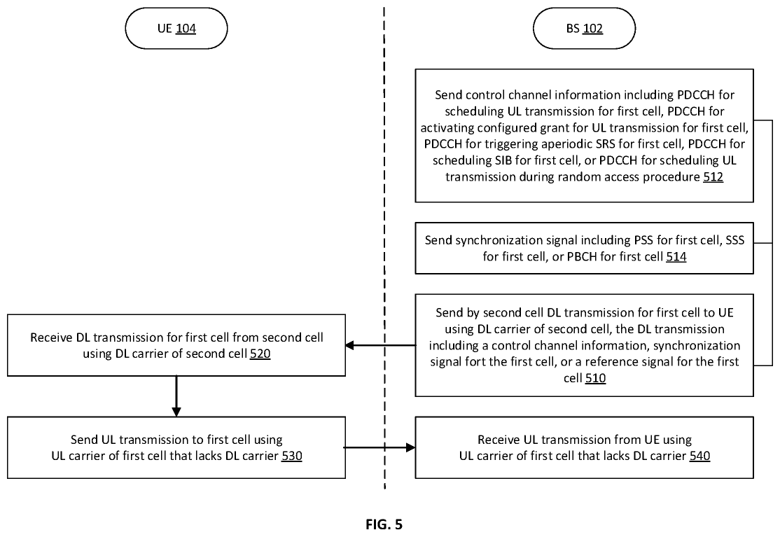

FIG. 4 is a diagram illustrating medium access control (MAC) control element (CE) configuration for uplink (UL) cell and SCell activation, according to various arrangements. As illustrated by way of example in FIG. 4, an example configuration 400 can include octets 410, 420 and 430. It is to be understood that present implementations are not limited to the number of octets illustrated herein by way of example. The octet 410 can include 7 C-fields and one R-field. The octet 420 can include a first SRS ID 422, a first SRS burst 424, a first gap 426, a first offset 428, and a first QCL 440. The octet 430 can include a first SRS ID 432, a first SRS burst 434, a first gap 436, a first offset 438, and a first QCL 442.

In some aspects, the measurement signal includes a number of Sounding Reference Signal (SRS) bursts, and an earliest slot of a preceding burst of the SRS bursts starts a number of time-domain resources after the latest SCell uplink slot coinciding with a latest downlink slot of a last Channel State Information Reference Signal (CSI-RS) burst.

Present implementations can include an SCell activation command.

The SCell activation command is a MAC CE, Downlink Control Information (DCI) or RRC signaling. The SCell activation command can indicate which SCell is to be activated, and can also indicate various information. The information can include the SRS ID. The SRS ID can indicate resource index or SRS resource set index used for SCell activation. If the SRS ID is set to 0 for the SCell, it indicates that no TRS is used for the corresponding SCell. The information can include the number of SRS bursts. The information can include the time gap between each two consecutive SRS bursts. The information can include the slot offset to determine the first slot of the first SRS burst. The information can include the QCL (Quasi co-location) info of the SRS.

If the SCell activation also triggers the aperiodic CSI-RS for SCell activation, it can also include various second information. Second information can include a CSI-RS resource set. Second information can include a number of the CSI-RS bursts. Second information can include a gap between the CSI-RS bursts. Second information can include a slot offset between the last CSI-RS burst and the first SRS burst.

By way of example of FIG. 2, the MAC CE can be used to indicate SCell activation for up to 7 SCells. It can have a variable size and include 7 C-fields and one R-field. It also can include several SRS ID fields, SRS bursts fields, gap fields, offset fields and QCL fields. With respect to Cᵢ, if there is an SCell configured for the MAC entity with SCellIndex i, this field indicates the activation/deactivation status of the SCell with SCellIndex i, else the MAC entity shall ignore the Cᵢ field. The Cᵢ field is set to 1 to indicate that the SCell with SCellIndex i shall be activated and that a SRS IDⱼ field is included for the SCell. The Cᵢ field is set to 0 to indicate that the SCell with SCellIndex i shall be deactivated and that no SRS ID field is included for this SCell.

With respect to SRS IDⱼ, SRS IDⱼ corresponds to the j-th SCell that shall be activated according to Cᵢ, i.e., SRS ID₁ corresponds to the activated SCell with the lowest sCellIndex value i₁ for which Cᵢ₁ is set to 1, SRS ID₂ corresponds to the activated SCell with the lowest SellIndex value i₂>i₁ for which Cᵢ₂ is set to 1, and so on until the activated SCell with the highest sCellIndex value i_{N} for which C_{iN} is set to 1. If SRS IDⱼ is set to a non-zero value, this field provides the scellActivationRS-ConfigId identifying a SCellActivationRS-Config, as configured in scellActivationRS-ConfigToAddModList for the corresponding SCell. If SRS IDⱼ is set to zero, no SRS is used for the corresponding SCell.

With respect to SRS bursts, SRS burstⱼ can indicate the number of SRS bursts for the j-th SCell that shall be activated according to Cᵢ. With respect to Gapⱼ, Gapⱼ can indicate the time gap between each two consecutive SRS bursts for the j-th SCell that shall be activated according to Cᵢ. With respect to Offsetⱼ, Offsetⱼ can indicate the slot offset to determine the first slot of the first SRS burst for the j-th SCell that shall be activated according to Cᵢ. With respect to QCLⱼ, QCLⱼ can indicate the QCL info of the SRS burst(s) for the j-th SCell that shall be activated according to Cᵢ. With respect to R, R can include a reserved bit, set to 0.

In some aspects, the SCell activation command is carried on a Media Access Control (MAC) Control Element (CE), a Downlink Control Information (DCI), or a Radio Resource Control signaling, the SCell activation command indicates at least one of which ones of the at least one SCell is to be activated, a Sounding Reference Signal (SRS) resource index or SRS resource set index used for the SCell activation, a number of SRS bursts of the measurement signal, a time gap between each two consecutive SRS bursts of the measurement signal, a slot offset used to determine an earliest slot of an earliest SRS burst of the measurement signal, Quasi Co-Location (QCL) info of the measurement signal, or a slot offset between a latest Channel State Information Reference Signal (CSI-RS) burst and the earliest SRS burst.

In some aspects, the SCell activation command is carried on a Media Access Control (MAC) Control Element (CE), a Downlink Control Information (DCI), or a Radio Resource Control signaling, the SCell activation command indicates at least one of which ones of the at least one SCell is to be activated, a Sounding Reference Signal (SRS) resource index or SRS resource set index used for the SCell activation, a number of SRS bursts of the measurement signal, a time gap between each two consecutive SRS bursts of the measurement signal, a slot offset used to determine an earliest slot of an earliest SRS burst of the measurement signal, Quasi Co-Location (QCL) info of the measurement signal, or a slot offset between a latest Channel State Information Reference Signal (CSI-RS) burst and the earliest SRS burst.

Present implementations can include an SCell activation command triggering SCell activation and a Random Access (RACH) preamble. The RACH preamble is a signal during RACH procedure, and can be the first signal in the RACH procedure. In other words, SCell activation command triggers SCell activation and a RACH procedure. As one example, one SCell activation command triggers both SCell activation and RACH procedure for one or multiple SCells. When one UE receives this SCell activation command to activate one SCell, UE initiates RACH procedure for this SCell. The initiated RACH procedure can be a 4-step RACH procedure or 2-step RACH process. As one example, the SCell activation command can be carried by MAC CE. The MAC CE indicates which SCell is to be activated. In addition to that, it also indicates at least various information. Information can include a Random Access Preamble index. Information can include a UL/SUL indicator that indicates which UL carrier between UL carrier and its supplementary UL carrier in the cell to transmit the PRACH. Information can include a SS/PBCH index that indicates the SS/PBCH that shall be used to determine the RACH occasion for the PRACH transmission. Information can include a PRACH Mask index that indicates the RACH occasion associated with the SS/PBCH indicated by “SS/PBCH index” for the PRACH transmission.

Upon receiving SCell activation command in slot n, at least one of the following timeline can apply. The UE can transmit RACH preamble no later than slot n+S1. S1 is a nonnegative integer number. The time duration between slot n and slot n+S1 is used for UE to prepare for the subsequent RACH procedure. The base station can transmit the PDSCH with UE contention resolution identity no later than n+S2. The base station can transmit the PDCCH scheduling the PDSCH with UE contention resolution identity no later than n+S3. The base station can transmit the PDSCH with MSGB information no later than n+S4. The base station can transmit the PDCCH scheduling the PDSCH with MSGB information no later than n+S5. Once the UE completes the RACH procedure successfully, UE completes the SCell activation procedure.

In some aspects, the measurement signal includes a Random Access Channel (RACH) preamble for the at least one SCell, the SCell activation command is carried on a Media Access Control (MAC) Control Element (CE), and the SCell activation command indicates at least one of which ones of the at least one SCell is to be activated, a Random Access Preamble index, uplink/supplemental uplink indicator indicating which uplink carrier from an uplink carrier and at least one supplementary uplink carrier in the cell is used to transmit a Physical Random Access Channel (PRACH), a Synchronization Signal (SS)/Physical Broadcast Channel (PBCH) index indicating an SS/PBCH used to determine a RACH occasion for transmitting the PRACH, a PRACH mask index indicating a RACH occasion associated with the SS/PBCH indicated by the SS/PBCH index for the transmitting the PRACH, where the wireless communication device completes the SCell activation after successfully completing the RACH procedure.

FIG. 5 is a diagram illustrating a first example method for uplink (UL) cell and SCell activation, according to various arrangements. At least one of the system 100, system 200, BS 102, and UE 104 can perform method 500 according to present implementations. The method 500 can begin at 510.

At 510, the method can send by a second cell a DL transmission for a first cell to UE using a DL carrier of a second cell, the DL transmission including a control channel information, synchronization signal fort the first cell, or a reference signal for the first cell. 510 can include at least one of steps 512 and 514. At 512, the method can send control channel information including PDCCH for scheduling UL transmission for a first cell, a PDCCH for activating a configured grant for a UL transmission for first cell, Pa DCCH for triggering aperiodic SRS for a first cell, a PDCCH for scheduling SIB for a first cell, or a PDCCH for scheduling UL transmission during a random access procedure. At 514, the method can send a synchronization signal including PSS for a first cell, SSS for a first cell, or PBCH for a first cell. The method 500 can then continue to 520. At 520, the method can receive a DL transmission for a first cell from second cell using DL carrier of a second cell. The method 500 can then continue to 530. At 530, the method can send UL transmission to a first cell using UL carrier of a first cell that lacks a DL carrier. The method 500 can then continue to 540. At 540, the method can receive UL transmission from a UE using UL carrier of a first cell that lacks a DL carrier. The method 500 can end at 540.

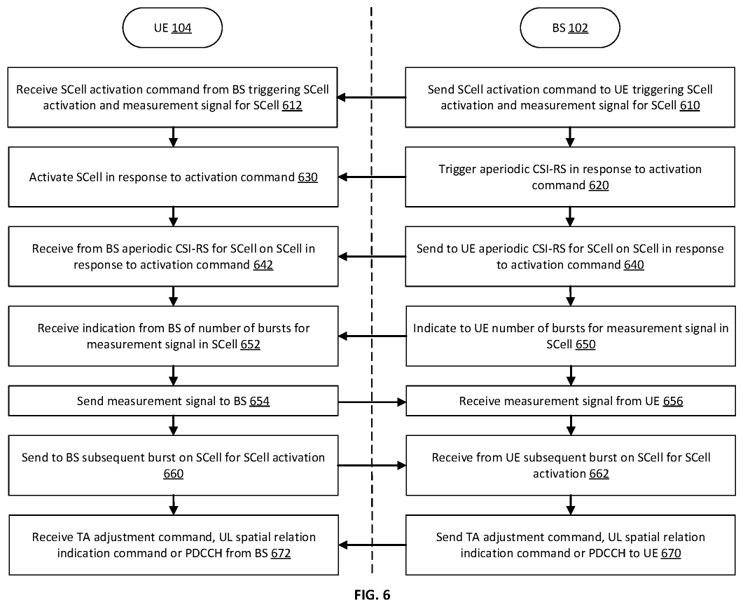

FIG. 6 is a diagram illustrating a second example method for uplink (UL) cell and SCell activation, according to various arrangements. At least one of the system 100, system 200, BS 102, and UE 104 can perform method 600 according to present implementations. The method 600 can begin at 610.

At 610, the method can send an SCell activation command from a BS triggering SCell activation and a measurement signal for the SCell. The method 600 can then continue to 612 and 620. At 612, the method can receive an SCell activation command from a BS triggering SCell activation and a measurement signal for the SCell. The method 600 can then continue to 630.

At 620, the method can trigger an aperiodic CSI-RS in response to the activation command. The method 600 can then continue to 630 and 640. At 630, the method can activate an SCell in response to the activation command. The method 600 can then continue to 642.

At 640, the method can send to UE aperiodic CSI-RS for SCell on SCell in response to an activation command. The method 600 can then continue to 642 and 652. At 642, the method can receive from BS aperiodic CSI-RS for SCell on SCell in response to activation command. The method 600 can then continue to 650.

At 650, the method can indicate to UE a number of bursts for a measurement signal in an SCell. The method 600 can then continue to 652 and 656. At 652, the method can receive an indication from BS of a number of bursts for a measurement signal in SCell. The method 600 can then continue to 654. At 654, the method can send the measurement signal to the BS. The method 600 can then continue to 656 and 660. At 656, the method can receive the measurement signal from the UE. The method 600 can then continue to 662.

At 660, the method can send to BS a subsequent burst on SCell for SCell activation. The method 600 can then continue to 662 and 672. At 662, the method can receive from UE subsequent burst on SCell for SCell activation. The method 600 can then continue to 670.

At 670, the method can send a TA adjustment command, UL spatial relation indication command or PDCCH to UE. The method 600 can then continue to 672. At 672, the method can receive a TA adjustment command, UL spatial relation indication command or PDCCH from BS. The method 600 can end at step 672.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

What is claimed is:

1. A wireless communication method, comprising;
sending, by a base station to a wireless communication device, a Secondary Cell (SCell) activation command triggering at least SCell activation and measurement signal for at least one SCell; and
receiving, by the base station from the wireless communication device, the measurement signal in response to the SCell activation command, wherein the wireless communication device activates the at least one SCell in response to the SCell activation command.

2. The method of claim 1, wherein
the SCell activation command further triggers aperiodic Channel State Information Reference Signal (CSI-RS);
the method further comprises sending, by the base station to the wireless communication device, the aperiodic CSI-RS for the at least one SCell on one or more of the at least one SCell; and
the wireless communication device sends the measurement signal after receiving the aperiodic CSI-RS.

3. The method of claim 1, further comprising transmitting, by the base station to the wireless communication device after the wireless communication device sends the measurement signal for the SCell activation, at least one of:
a Time Alignment (TA) adjustment command;
a Transmit power control (TPC) command;
an uplink spatial relationship indication command;
a Physical Downlink Control Channel (PDCCH) on the at least one SCell; or
a PDCCH for the at least one SCell.

4. The method of claim 1, wherein
the measurement signal comprises a number of bursts;
the number is an integer larger than 0;
the number is indicated by the base station or a default number;
the burst is at least one of:
a first number of Sounding Reference Signal (SRS) resources in one slot, where the first number is integer number larger than 0;
a second number of SRS resources in each of a third number of slots, wherein each of the second number and the third number is an integer number larger than 1; or
one SRS resource set.

5. The method of claim 4, wherein
a time gap between two consecutive bursts is configured or indicated to the wireless communication device by the base station, wherein the time gap is a non-negative integer, the time gap is defined by a number of time-domain resources, the wireless communication device transmits a subsequent one of the two consecutive bursts the time gap after an end of a preceding one of the two consecutive bursts; or
indication of the time gap by the base station is absent, and the time gap is 0.

6. The method of claim 4, wherein
the measurement signal comprises a number of bursts;
the number of bursts is 2 in response to:
a time gap between two consecutive bursts is indicated to the wireless communication device by the base station; and
one of:
indication of the number by the base station being absent;
or the base station configures, or indicates the number to be 1.

7. The method of claim 1, wherein
for the SCell activation, the measurement signal triggered by the SCell activation command is aperiodic Sounding Reference Signal (SRS).

8. The method of claim 1, wherein
for the SCell activation, a usage of the measurement triggered by the SCell activation command is configured as beam management, and the base station performs uplink beam management during the SCell activation.

9. The method of claim 1, further comprising indicating, by the base station to the wireless communication device a slot offset for the SCell, wherein the slot offset is a non-negative integer number, an earliest slot of a first SRS burst starts at a slot that is the slot offset after a latest SCell slot coinciding with a reference slot of a cell.

10. The method of claim 1, further comprising:
indicating, by the base station to the wireless communication device, a number of bursts for the measurement signal in a SCell of the at least one SCell, the number being greater than 1; and
receiving, by the base station from the wireless communication device, a subsequent burst on the SCell for the SCell activation, wherein an earliest slot of the subsequent burst starts at a slot that is a time gap after an end of a preceding burst, the time gap is indicated by the base station.

11. The method of claim 1, wherein
the measurement signal comprises a number of Sounding Reference Signal (SRS) bursts; and
an earliest slot of a preceding burst of the SRS bursts starts a number of time-domain resources after the latest SCell uplink slot coinciding with a latest downlink slot of a last Channel State Information Reference Signal (CSI-RS) burst.

12. The method of claim 1, wherein
the SCell activation command is carried on a Media Access Control (MAC) Control Element (CE), a Downlink Control Information (DCI), or a Radio Resource Control signaling;
the SCell activation command indicates at least one of:
which ones of the at least one SCell is to be activated;
a Sounding Reference Signal (SRS) ID indicating resource index or SRS resource set index used for the SCell activation;
a number of SRS bursts of the measurement signal;
a time gap between each two consecutive SRS bursts of the measurement signal;
a slot offset used to determine an earliest slot of an earliest SRS burst of the measurement signal;
Quasi Co-Location (QCL) info of the measurement signal; or
a slot offset between a latest Channel State Information Reference Signal (CSI-RS) burst and the earliest SRS burst.

13. The method of claim 1, wherein
the measurement signal comprises a Random Access Channel (RACH) preamble for the at least one SCell;
the SCell activation command is carried on a Media Access Control (MAC) Control Element (CE); and
the SCell activation command indicates at least one of:
which ones of the at least one SCell is to be activated;
a Random Access Preamble index;
uplink/supplemental uplink indicator indicating which uplink carrier from an uplink carrier and at least one supplementary uplink carrier in the cell is used to transmit a Physical Random Access Channel (PRACH);
a Synchronization Signal (SS)/Physical Broadcast Channel (PBCH) index indicating an SS/PBCH used to determine a RACH occasion for transmitting the PRACH;
a PRACH mask index indicating a RACH occasion associated with the SS/PBCH indicated by the SS/PBCH index for the transmitting the PRACH.

14. A wireless communication method, comprising:
receiving, by a wireless communication device from a base station to a Secondary Cell (SCell) activation command triggering at least SCell activation and measurement signal for at least one SCell; and
in response to receiving the SCell activation command,
sending, by wireless communication device to the base station, the measurement signal; and
activating, by the wireless communication device, the at least one SCell.

15. The method of claim 14, wherein
the SCell activation command further triggers aperiodic Channel State Information Reference Signal (CSI-RS);
the method further comprises sending, by the wireless communication device from the base station, the aperiodic CSI-RS for the at least one SCell on one or more of the at least one SCell; and
the wireless communication device sends the measurement signal after receiving the aperiodic CSI-RS.

16. The method of claim 14, further comprising receiving, by the wireless communication device from the base station after the wireless communication device sends the measurement signal for the SCell activation, at least one of commands comprising:
a Time Alignment (TA) adjustment command;
a Transmit power control (TPC) command;
an uplink spatial relationship indication command;
a Physical Downlink Control Channel (PDCCH) on the at least one SCell; or
a PDCCH for the at least one SCell, wherein the wireless communication device completes the SCell activation after receiving the at least one of the commands.

17. The method of claim 14, wherein
the measurement signal comprises a number of bursts;
the number is an integer larger than 0;
the number is indicated by the base station or a default number;
the burst is at least one of:
a first number of Sounding Reference Signal (SRS) resources in one slot, where the first number is integer number larger than 0;
a second number of SRS resources in each of a third number of slots, wherein each of the second number and the third number is an integer number larger than 1; or
one SRS resource set.

18. The method of claim 15, wherein
a time gap between two consecutive bursts is configured or indicated to the wireless communication device by the base station, wherein the time gap is a non-negative integer, the time gap is defined by a number of time-domain resources, the wireless communication device transmits a subsequent one of the two consecutive bursts the time gap after an end of a preceding one of the two consecutive bursts; or
configuration or indication of the time gap by the base station is absent, and the time gap is 0.

19. Abase station, comprising;
at least one processor configured to:
send, via a transceiver to a wireless communication device, a Secondary Cell (SCell) activation command triggering at least SCell activation and measurement signal for at least one SCell; and
receive, via the transceiver from the wireless communication device, the measurement signal in response to the SCell activation command, wherein the wireless communication device activates the at least one SCell in response to the SCell activation command.

20. A wireless communication device, comprising:
at least one processor configured to:
receive, via a transceiver from a base station to a Secondary Cell (SCell) activation command triggering at least SCell activation and measurement signal for at least one SCell; and
in response to receiving the SCell activation command,
send, via the transceiver to the base station, the measurement signal; and
activate the at least one SCell.
